(19) United States
(12) Patent Application Publication
(10) Pub. No.: US 2025/0353150 A1
(43) Pub. Date: Nov. 20, 2025

(54) ELECTRIC TOOL SYSTEM, DIAGNOSIS METHOD, AND PROGRAM

(71) Applicant: PANASONIC HOLDINGS CORPORATION, Osaka (JP)

(72) Inventors: Keita OKAMOTO, Mie (JP); Masaki IKEDA, Shiga (JP); Koichi HASHIMOTO, Shiga (JP)

(21) Appl. No.: 18/874,454

(22) PCT Filed: Jun. 21, 2023
(86) PCT No.: PCT/JP2023/022996

§ 371 Date: Dec. 12, 2024

(30) Foreign Application Priority Data
Jul. 4, 2022 (JP) 2022-107895

(51) Int. Cl. B25B 23/147; B25F 5/02

(52) U.S. Cl. CPC B25B 23/1475; B25F 5/029

(57) ABSTRACT

An electric tool system includes an electric tool section, a measuring unit, a storage unit, and an estimation unit. The measuring unit measures a physical quantity concerning the electric tool section. The storage unit stores a failure diagnostic value in association with time information about a point in time when the physical quantity is measured. The failure diagnostic value is at least one of the physical quantity measured by the measuring unit or an arithmetic value calculated based on the physical quantity. The estimation unit obtains, based on the failure diagnostic value and the time information that are stored in the storage unit, expected lifetime information about an estimated amount of time that is expected to take for the electric tool section to cause any failure.

### TECHNICAL FIELD

The present disclosure generally relates to an electric tool system, a diagnosis method, and a program. More particularly, the present disclosure relates to an electric tool system, a diagnosis method, and a program, all of which are configured or designed to obtain information about any failure that an electric tool section would cause.

### BACKGROUND ART

Patent Literature 1 discloses an electric tool including a motor, an acquisition unit, a storage unit, and a transmission unit. The acquisition unit acquires physical quantity data detected while the motor is running. The storage unit stores the physical quantity data in association with time information about a time when the physical quantity data is acquired. The transmission unit transmits the physical quantity data and the time information to a server system. The server system evaluates the current condition of the electric tool by the physical quantity data and the time information.

According to Patent Literature 1, the user, for example, needs to determine, based on the current condition of the electric tool (electric tool section) which has been evaluated by the server system, when it is about time to make management (e.g., maintenance and replacement) of the electric tool (electric tool section). However, sometimes it is difficult to decide when it is about time to make the management.

### CITATION LIST

### Patent Literature

Patent Literature 1: JP 2020-038580 A

### SUMMARY OF INVENTION

An object of the present disclosure is to provide an electric tool system, a diagnosis method, and a program, all of which make it easier for the user, for example, to decide when it is about time to make management (such as maintenance and replacement) of a given electric tool section.

An electric tool system according to an aspect of the present disclosure includes an electric tool section, a measuring unit, a storage unit, and an estimation unit. The electric tool section includes a driving part, an attachment part, and a transmission part. The driving part is supplied with motive power by a power source and thereby generates torque. A tip tool is attachable to the attachment part. The transmission part transmits the torque from the driving part to the attachment part and thereby drives the attachment part. The measuring unit measures a physical quantity concerning the electric tool section. The storage unit stores a failure diagnostic value in association with time information about a point in time when the physical quantity is measured. The failure diagnostic value is at least one of the physical quantity measured by the measuring unit or an arithmetic value calculated based on the physical quantity. The estimation unit obtains, based on the failure diagnostic value and the time information that are stored in the storage unit, expected lifetime information about an estimated amount of time that is expected to take for the electric tool section to cause any failure.

A diagnosis method according to another aspect of the present disclosure is a method for making a diagnosis about an electric tool section. The electric tool section includes a driving part, an attachment part, and a transmission part. The driving part is supplied with motive power by a power source and thereby generates torque. A tip tool is attachable to the attachment part. The transmission part transmits the torque from the driving part to the attachment part and thereby drives the attachment part. The diagnosis method includes a storing step and an estimating step. The storing step includes storing, in a storage unit, a failure diagnostic value in association with time information about a point in time when a physical quantity concerning the electric tool section is measured by a measuring unit. The failure diagnostic value is at least one of the physical quantity concerning the electric tool section which has been measured by the measuring unit or an arithmetic value calculated based on the physical quantity. The estimating step includes obtaining, based on the failure diagnostic value and the time information that are stored in the storage unit, expected lifetime information about an estimated amount of time that is expected to take for the electric tool section to cause any failure.

A program according to still another aspect of the present disclosure is designed to cause one or more processors of a computer system to perform the diagnosis method described above.

### BRIEF DESCRIPTION OF DRAWINGS

FIG. 1 is a block diagram of an electric tool system according to an exemplary embodiment;

FIG. 2 is a perspective view of an electric tool section of the electric tool system;

FIG. 3 is a schematic representation of the electric tool section of the electric tool system;

FIG. 4 schematically illustrates how the electric tool system performs the processing of obtaining expected lifetime information; and

FIG. 5 is a flowchart showing the procedure of operation of the electric tool system.

### DESCRIPTION OF EMBODIMENTS

### Embodiment

An electric tool system 100, a diagnosis method, and a program according to an exemplary embodiment will be described with reference to the accompanying drawings. Note that the embodiment to be described below is only an exemplary one of various embodiments of the present disclosure and should not be construed as limiting. Rather, the exemplary embodiment may be readily modified in various manners depending on a design choice or any other factor without departing from the scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio.

### Overview

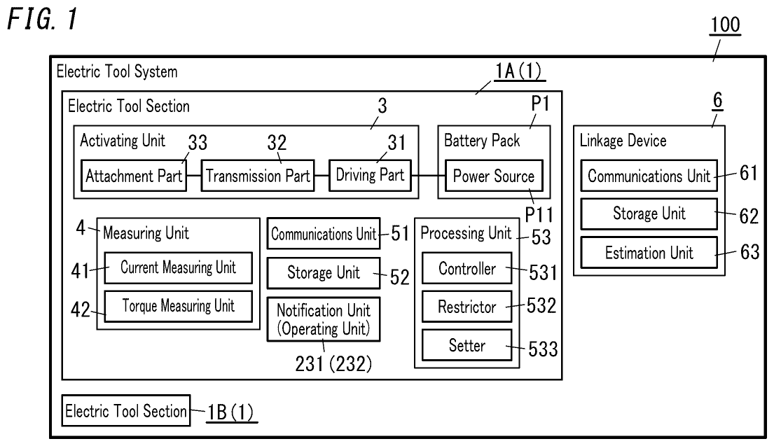

As shown in FIG. 1, an electric tool system 100 according to an exemplary embodiment includes an electric tool section 1, a measuring unit 4, a storage unit 62, and an estimation unit 63. The electric tool section 1 includes a driving part 31, an attachment part 33, and a transmission part 32. The driving part 31 is supplied with motive power by a power source P11 to generate torque. A tip tool is attachable to the attachment part 33. The transmission part 32 transmits the torque from the driving part 31 to the attachment part 33 and thereby drives the attachment part 33. The measuring unit 4 measures a physical quantity concerning the electric tool section 1. The storage unit 62 stores a failure diagnostic value in association with time information about a point in time when the physical quantity is measured. The failure diagnostic value is at least one of the physical quantity measured by the measuring unit 4 or an arithmetic value calculated based on the physical quantity. The estimation unit 63 obtains, based on the failure diagnostic value and the time information that are stored in the storage unit 62, expected lifetime information about an estimated amount of time that is expected to take for the electric tool section 1 to cause any failure.

According to this embodiment, the estimation unit 63 obtains expected lifetime information about an estimated amount of time that it would take for the electric tool section 1 to cause any failure, thus making it easier for the user, for example, to decide, by reference to the expected lifetime information, when it is about time to make management (such as maintenance and replacement) of the electric tool section 1. That is to say, this makes the user, for example, prepared for any failure that may occur to the electric tool section 1 unlike a situation where a determination is simply made whether the electric tool section 1 has caused any failure.

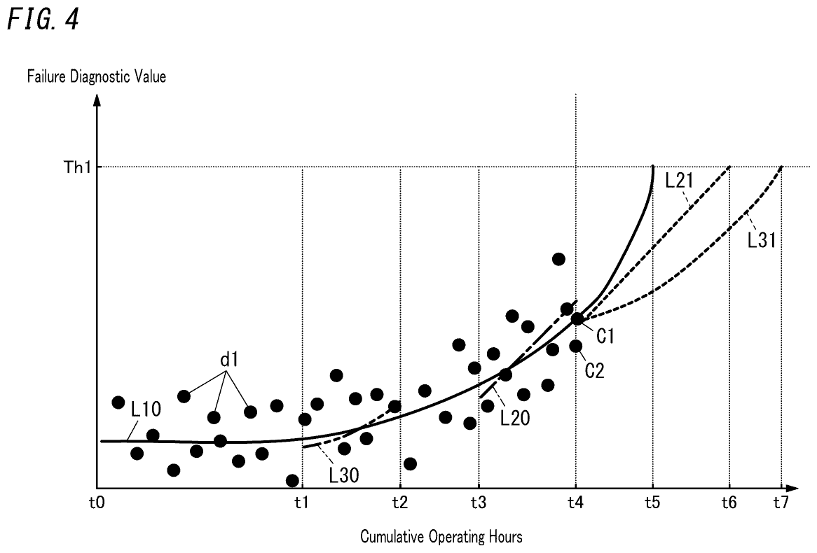

For example, as indicated by the plurality of dots d1 in FIG. 4, a failure diagnostic value at each of multiple points in time from a time to through a time t4 is stored in the storage unit 62 in association with a piece of time information indicating a point in time (time and date) when a physical quantity is measured. The estimation unit 63 estimates, based on respective failure diagnostic values and the time information associated with the failure diagnostic values, how the failure diagnostic value will change from the time t4 on. In the example shown in FIG. 4, an approximate curve L10 (indicated by the solid curve) indicating how the failure diagnostic value changes may be plotted based on all failure diagnostic values from a time to through a time t4 which is represented by the cumulative operating hours of the electric tool section 1 and the estimated values of the failure diagnostic values from the time t4 on are obtained by reference to the approximate curve L10. As used herein, the “cumulative operating hours” refers to the sum of the operating hours of the electric tool section 1 since the electric tool section 1 was used for the first time.

In addition, the estimation unit 63 obtains, based on the estimated values of the failure diagnostic values from the time t4 on, expected lifetime information about an estimated amount of time that it would take for the electric tool section to cause any failure. In this embodiment, the estimation unit 63 estimates a point in time when the failure diagnostic value reaches a threshold value Th1 to be a point in time when the electric tool section 1 will cause a failure. Estimating the point in time when the electric tool section 1 will cause a failure is synonymous with obtaining expected lifetime information.

Furthermore, the functions of the electric tool system 100 may also be implemented as a diagnosis method. A diagnosis method according to an exemplary embodiment is a method for making a diagnosis about an electric tool section 1. The electric tool section 1 includes a driving part 31, an attachment part 33, and a transmission part 32. The driving part 31 is supplied with motive power by a power source P11 to generate torque. A tip tool is attachable to the attachment part 33. The transmission part 32 transmits the torque from the driving part 31 to the attachment part 33 and thereby drives the attachment part 33. The diagnosis method includes a storing step and an estimating step. The storing step includes storing, in a storage unit 62, a failure diagnostic value in association with time information about a point in time when a physical quantity concerning the electric tool section 1 is measured by a measuring unit 4. The failure diagnostic value is at least one of the physical quantity concerning the electric tool section 1 which has been measured by the measuring unit 4 or an arithmetic value calculated based on the physical quantity. The estimating step includes obtaining, based on the failure diagnostic value and the time information that are stored in the storage unit 62, expected lifetime information about an estimated amount of time that is expected to take for the electric tool section 1 to cause any failure.

Furthermore, the diagnosis method may also be implemented as a program. A program according to an exemplary embodiment is designed to cause one or more processors of a computer system to perform the diagnosis method described above. The program may be stored in a non-transitory storage medium, which is readable for a computer system.

### Details

### (1) Overall Configuration

The electric tool system 100 will now be described in further detail.

As shown in FIG. 1, the electric tool system 100 includes an electric tool section 1 and a linkage device 6

The electric tool section 1 is a device to which a tip tool is attachable. Examples of the tip tool include a drill bit and a screwdriver bit. The user (operator) uses the electric tool section 1 for the purpose of performing the operations of drilling a hole or fastening a screw, for example. The electric tool section 1 is also a portable device (handheld device).

The linkage device 6 includes a computer system. The linkage device 6 may be, for example, an industrial computer, a personal computer, a tablet computer, or a cellphone such as a smartphone. The linkage device 6 communicates with the electric tool section 1. The linkage device 6 processes information acquired from the electric tool section 1, thereby obtaining expected lifetime information.

In particular, in the following description of embodiments, the electric tool system 100 is supposed to be used on an assembly line where a plurality of users perform the operations of assembling a plurality of workpieces. The electric tool system 100 includes a plurality of (e.g., two in the example shown in FIG. 1) electric tool sections 1. One electric tool section 1A out of the two electric tool sections 1 is used by a first user, while the other electric tool section 1B is used by a second user different from the first user. These two electric tool sections 1A, 1B have the same configuration. Thus, the following description will be focused on the one electric tool section 1A unless otherwise stated.

### (2) Electric Tool Section

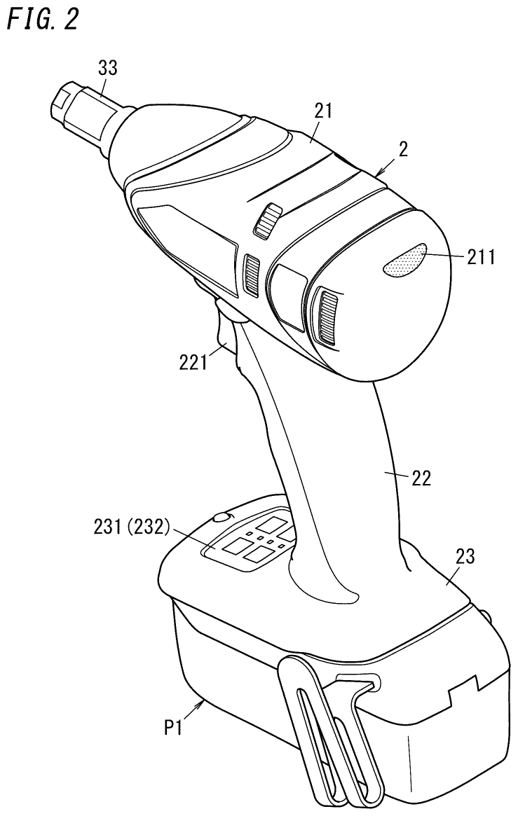

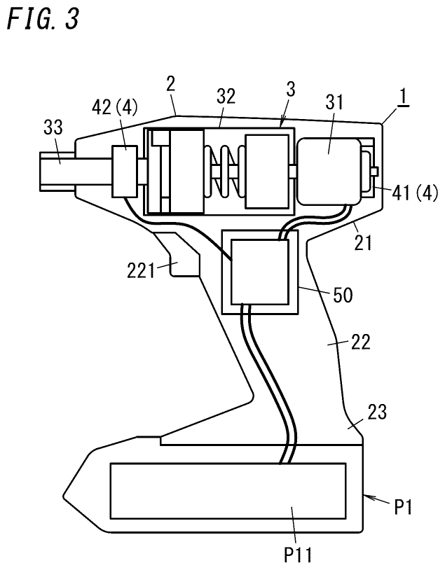

As shown in FIG. 1, the electric tool section 1 includes an activating unit 3, a battery pack P1, the measuring unit 4, a communications unit 51, a storage unit 52, a processing unit 53, and a notification unit 231. The activating unit 3 includes the attachment part 33, the transmission part 32, and the driving part 31. Also, as shown in FIGS. 2 and 3, the electric tool section 1 further includes a housing 2, an indicator 211, a trigger switch 221, and a box 50.

### (3) Housing

The housing 2 houses the transmission part 32, the driving part 31, the measuring unit 4, the processing unit 53, and other members. The housing 2 includes a housing portion 21, a grip portion 22, and an attachment portion 23.

The housing portion 21 has a cylindrical shape. The housing portion 21 houses the transmission part 32, the driving part 31, the measuring unit 4, and other members.

The indicator 211 is held on the surface of the housing portion 21. Examples of the indicator 211 include a light-emitting diode (LED). The indicator 211 is provided at an end, opposite from the attachment part 33, of the housing portion 21 to allow the user to visually recognize the indicator 211 easily while performing the operations (refer to FIG. 2). The indicator 211 notifies the user of the status of the electric tool section 1 by flashing, for example.

The grip portion 22 protrudes in one direction aligned with the radius of the housing portion 21 from an outer peripheral surface of the housing portion 21. The grip portion 22 is formed in the shape of a hollow cylinder elongate in the one direction. The grip portion 22 is a part to be held by the user while he or she is performing the operations of fastening a screw, for example. The trigger switch 221 is held by the grip portion 22. The trigger switch 221 is a switch for use to control the ON/OFF states of the driving part 31.

The housing portion 21 is connected to one longitudinal end of the grip portion 22. The attachment portion 23 is connected to the other longitudinal end of the grip portion 22.

In addition, the box 50 (refer to FIG. 3) is further housed in the grip portion 22. The box 50 houses, for example, the communications unit 51 (refer to FIG. 1), the storage unit 52, and the processing unit 53.

The battery pack P1 is attached removably to the attachment portion 23. In this embodiment, the battery pack P1 is supposed to be one of the constituent elements of the electric tool section 1. However, the battery pack P1 may also be counted out of the constituent elements of the electric tool section 1.

The battery pack P1 includes, as the power source P11, either a primary battery or a secondary battery. The electric tool section 1 is activated with the electric power supplied from the power source P11. That is to say, the power source P11 supplies electric power for driving the driving part 31 (motor). In addition, the power source P11 also supplies electric power for activating the communications unit 51, the processing unit 53, and other components.

In addition, the notification unit 231 is held by the attachment portion 23. The notification unit 231 includes a display device such as a display for providing visually notification of information, for example. The notification unit 231 is also integrated with an operating unit 232. The operating unit 232 may include, for example, a plurality of buttons. The operating unit 232 accepts an operating command entered by the user. The user may check various statuses of the electric tool section 1 using the notification unit 231. For example, the user may check the expected lifetime information, the battery level of the battery pack P1, and the operation mode of the electric tool section 1 using the notification unit 231. In addition, the user may also make various settings about the electric tool section 1 using the operating unit 232. For example, the user may change the operation mode of the electric tool section 1 using the notification unit 231.

### (4) Driving Part

The driving part 31 shown in FIG. 3 may be, for example, a servo motor. The driving part 31 transforms the electrical energy supplied from the power source P11 into torque. The torque and the number of revolutions of the driving part 31 vary under the control of a controller 531 (refer to FIG. 1). The controller 531 is a servo driver. The controller 531 controls the operation of the driving part 31 by, for example, performing feedback control for bringing the torque and number of revolutions of the driving part 31 closer toward target values.

The controller 531 (refer to FIG. 1) detects the manipulative variable of the trigger switch 221 (i.e., how deep the trigger switch 221 has been pulled) and controls the driving part 31 according to the manipulative variable. When the trigger switch 221 is pulled by the user, the driving part 31 is activated with the motive power supplied from the power source P11, thus generating torque. In addition, the controller 531 adjusts the target value of the number of revolutions of the driving part 31 (motor) in accordance with the manipulative variable of the trigger switch 221.

### (5) Transmission Part

The transmission part 32 transmits the torque of the driving part 31 to the attachment part 33. This causes the attachment part 33 to rotate.

The transmission part 32 may include, for example, a planetary gear mechanism. The planetary gear mechanism is a speed reducer. That is to say, the transmission part 32 causes the attachment part 33 to rotate at a smaller number of revolutions than the number of revolutions of the driving part 31.

### (6) Attachment Part

A tip tool is attached to the attachment part 33. Examples of the tip tool include a drill bit and a screwdriver bit. Any of various types of tip tools may be attached removably to the attachment part 33 depending on the intended use. Alternatively, only a particular tip tool may be attached to the attachment part 33.

As the torque is transmitted from the driving part 31 to the attachment part 33 via the transmission part 32, the tip tool rotates along with the attachment part 33. This allows the user to perform operations such as drilling a hole or fastening a screw using the electric tool section 1.

### (7) Measuring Unit

The measuring unit 4 measures a physical quantity concerning the electric tool section 1. More specifically, the measuring unit 4 measures a physical quantity concerning the operation of the activating unit 3. The measuring unit 4 according to this embodiment includes a current measuring unit 41 and a torque measuring unit 42. The current measuring unit 41 measures, as the physical quantity, the amount of current supplied from the power source P11 to the driving part 31. The torque measuring unit 42 measures, as the physical quantity, the torque of the attachment part 33.

The current measuring unit 41 is provided for an electrical path between the power source P11 and the driving part 31. The current measuring unit 41 includes, for example, a shunt resistor or a Hall element and outputs a voltage proportional to the current to be measured.

The torque measuring unit 42 may include, for example, a magnetostrictive strain sensor or a resistive strain sensor.

The magnetostrictive strain sensor makes a coil, which is disposed in a non-rotating part in the vicinity of the attachment part 33, detect a variation in magnetic permeability responsive to the strain caused upon the application of torque to the attachment part 33 and outputs a voltage signal proportional to the strain.

The resistive strain sensor is affixed onto the surface of the attachment part 33. The resistive strain sensor transforms a variation in electrical resistance value responsive to the strain caused upon the application of the torque to the attachment part 33 into a voltage signal and outputs the voltage signal.

### (8) Communications Unit

The communications unit 51 (refer to FIG. 1) includes a communications interface device. The communications unit 51 is ready to communicate with a communications unit 61 of the linkage device 6 via the communications interface device. As used herein, the phrase “to be ready to communicate” means being able to transmit and receive signals either directly or indirectly via a network or a repeater, for example, by an appropriate wired or wireless communication method.

### (9) Storage Unit

The storage unit 52 (refer to FIG. 1) is a nonvolatile storage device which may be implemented as, for example, a hard disk drive (HDD) or a solid-state drive (SSD). The storage unit 52 stores the physical quantity measured by the measuring unit 4 in association with the time information.

### (10) Notification Unit

The notification unit 231 (refer to FIG. 2) makes notification of the expected lifetime information obtained by the estimation unit 63. The notification unit 231 makes notification of the expected lifetime information by displaying the expected lifetime information, for example.

### (11) Processing Unit

The electric tool section 1 includes a computer system including one or more processors and a memory. The processing unit 53 (refer to FIG. 1) includes the one or more processors of the electric tool section 1. The functions of the processing unit 53 are performed by making the one or more processors of the processing unit 53 execute a program stored in the memory. The program may be stored in the memory. Alternatively, the program may also be downloaded via a telecommunications line such as the Internet or distributed after having been stored in a non-transitory storage medium such as a memory card.

As shown in FIG. 1, the processing unit 53 includes the controller 531, a restrictor 532, and a setter 533. Note that these constituent elements only represent the respective functions to be performed by the processing unit 53 and do not necessarily have a substantive configuration.

The controller 531 detects the manipulative variable of the trigger switch 221 (refer to FIG. 2) to control the number of revolutions of the driving part 31 according to the manipulative variable.

The restrictor 532 restricts (e.g., prevents) the notification of the expected lifetime information by the notification unit 231 while the attachment part 33 is being driven. For example, the restrictor 532 controls the notification unit 231 to prevent the notification unit 231 from displaying the expected lifetime information while the attachment part 33 is being driven.

As will be described later, the estimation unit 63 of the linkage device 6 obtains, as the expected lifetime information, the estimated amount of time that it would take for the failure diagnostic value to reach a value falling within the predetermined range. Taking the electric tool section 1A out of the two electric tool sections 1A, 1B, for example, the setter 533 sets the predetermined range in accordance with information provided by the electric tool section 1B, which is provided separately from the electric tool section 1A as will be described in detail later.

### (12) Linkage Device

As shown in FIG. 1, the linkage device 6 includes the communications unit 61, the storage unit 62, and the estimation unit 63.

The communications unit 61 includes a communications interface device. The communications unit 61 is ready to communicate with the communications unit 51 of the electric tool section 1 via the communications interface device.

The storage unit 62 is a nonvolatile storage device which may be implemented as, for example, a hard disk drive (HDD) or a solid-state drive (SSD). The storage unit 62 stores the failure diagnostic value in association with the time information.

The linkage device 6 includes a computer system including one or more processors and a memory. The estimation unit 63 includes the one or more processors of the linkage device 6. The functions of the estimation unit 63 are performed by making the one or more processors of the estimation unit 63 execute a program stored in the memory. The program may be stored in the memory. Alternatively, the program may also be downloaded via a telecommunications line such as the Internet or distributed after having been stored in a non-transitory storage medium such as a memory card.

The estimation unit 63 obtains expected lifetime information about the estimated amount of time that it would take for the electric tool section 1 to cause any failure. In particular, the estimation unit 63 according to this embodiment obtains expected lifetime information about the estimated amount of time that it would take for the activating unit 3, including the driving part 31, the transmission part 32, and the attachment part 33, of the electric tool section 1 to cause any failure.

### (13) How to Obtain Expected Lifetime Information

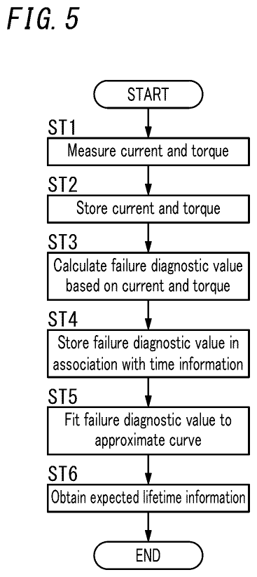

Next, a diagnosis method according to the present disclosure, i.e., a series of processing steps in which the estimation unit 63 obtains (or generates) the expected lifetime information, will be described with reference to FIGS. 4 and 5. Note that the flowchart shown in FIG. 5 shows only an exemplary procedure of the diagnosis method according to the present disclosure and should not be construed as limiting. Optionally, the processing steps shown in FIG. 5 may be performed in a different order from the illustrated one, some of the processing steps shown in FIG. 5 may be omitted as appropriate, and/or an additional processing step may be performed as needed.

The estimation unit 63 may obtain the expected lifetime information in a regular cycle, for example. Alternatively, the estimation unit 63 may obtain the expected lifetime information upon receiving a command signal requesting the expected lifetime information. Still alternatively, the estimation unit 63 may obtain the expected lifetime information in a regular cycle after the cumulative operating hours of the electric tool section 1 has exceeded a certain amount of time, for example.

As described above, the measuring unit 4 measures the current supplied from the power source P11 to the driving part 31 and the torque of the attachment part 33 (in Step ST1 shown in FIG. 5). The communications unit 61 acquires, by communicating with the communications unit 51 of the electric tool section 1, the current and torque that are physical quantities measured by the measuring unit 4 and the time information associated with the current and the torque. More specifically, the current and torque measured by the measuring unit 4 are stored in the storage unit 52 of the electric tool section 1 in association with the information about the measuring time (i.e., time information). The communications unit 51 transmits the current, torque, and time information stored in the storage unit 52 to the communications unit 61 of the linkage device 6.

Subsequently, the storage unit 62 stores the current, torque, and time information that have been acquired by the communications unit 61 (in Step ST2). More specifically, the storage unit 62 stores the current and torque in association with the time information.

Every time the electric tool section 1 performs the operations of fastening a screw, for example, the measuring unit 4 measures the physical quantities (i.e., the current and torque) and the storage unit 62 stores the respective physical quantities. Alternatively, the storage unit 62 may store the average value of each of these physical quantities over every certain period. For example, the storage unit 62 may store the average value of the physical quantity that has been measured per day.

The estimation unit 63 calculates the failure diagnostic value based on the current and torque that have been measured by the measuring unit 4 and then stored in the storage unit 62. For example, first, the estimation unit 63 calculates, based on the current measured by the measuring unit 4 and then stored in the storage unit 62, a theoretical value of the torque produced by the attachment part 33 with this current. In the following description, the torque calculated based on the current measured by the measuring unit 4 will be hereinafter referred to as “theoretical torque” and the torque measured by the measuring unit 4 will be hereinafter referred to as “actually measured torque.” In this embodiment, the estimation unit 63 defines a value calculated by subtracting the actually measured torque from the theoretical torque as the failure diagnostic value, as an example. That is to say, the estimation unit 63 calculates the failure diagnostic value based on the current and the actually measured torque (in Step ST3).

The storage unit 62 stores the failure diagnostic value in association with the time information (in Step ST4).

The plurality of dots d1 shown in FIG. 4 indicate correspondence between a point in time when the current and the actually measured torque are measured (i.e., time information) and the failure diagnostic value calculated based on the current and the actually measured torque that have been measured at that point in time. The estimation unit 63 obtains, as expected lifetime information, the estimated amount of time that it would take for the failure diagnostic value at a current time (i.e., the point in time t4) to reach a value falling within a predetermined range. As used herein, the “current time” refers to the latest point in time when measuring is done by the measuring unit 4.

In this embodiment, a range where the value is greater than the threshold value Th1 is defined to be the predetermined range. That is to say, the estimation unit 63 obtains, as the expected lifetime information, the estimated amount of time that it would take for the failure diagnostic value to exceed the threshold value Th1.

When any abnormality such as deterioration occurs to the transmission part 32, the loss involved with the transformation of the input current supplied to the driving part 31 into the torque of the attachment part 33 increases to cause a decrease in the actually measured torque with respect to the theoretical torque. Consequently, the failure diagnostic value increases.

For example, if the intended use of the electric tool section 1 is fastening screws, then the number of screws that have been fastened using the electric tool section 1 corresponds to the cumulative operating hours of the electric tool section 1. Basically, the longer the cumulative operating hours of the electric tool section 1 are, the higher the chances of the electric tool section 1 causing any failure will be. Thus, basically, the longer the cumulative operating hours of the electric tool section 1 are, the more significantly the failure diagnostic value would increase.

As shown in FIG. 4, the estimation unit 63 plots, based on, for example, all failure diagnostic values from the time to through the time t4, the approximate curve L10 (shown as a solid curve) showing how the failure diagnostic value changes. In other words, the estimation unit 63 fits the failure diagnostic values to the approximate curve L10 (in Step ST5). Furthermore, the estimation unit 63 estimates the failure diagnostic values from the time t4 on by reference to the approximate curve L10. Thus, in the example shown in FIG. 4, the estimation unit 63 estimates that the failure diagnostic value will reach the threshold value Th1 at a time t5. The estimation unit 63 obtains, as the expected lifetime information, the amount of time that has passed from the time t4 to the time t5 (in Step ST6). As can be seen, the estimation unit 63 may obtain the expected lifetime information based on the failure diagnostic values belonging to the entire period (i.e., from the time t0 through the time t4) and time information that are stored in the storage unit 62, for example. The approximate curve L10 may be plotted by, for example, the least squares method. The estimation unit 63 may obtain the expected lifetime information accurately by plotting the approximate curve L10 based on a large number of data (failure diagnostic values) belonging to the entire period which are stored in the storage unit 62.

In another example, the estimation unit 63 may obtain the expected lifetime information based on failure diagnostic values belonging to a certain period and time information, instead of the failure diagnostic values belonging to the entire period and the time information which are stored in the storage unit 62. In this case, the certain period is a partial period forming part of the entire period. The partial period may be a period from a time t3 preceding the current time (time t4) through the current time. More specifically, the estimation unit 63 plots an approximate curve L20 (plotted as a one-dot chain curve) indicating how the failure diagnostic value changes from the time t3 through the time t4. Then, the estimation unit 63 estimates, on the supposition that failure diagnostic value changes along the approximate curve L20 from the time t4 on, the failure diagnostic values from the point t4 on. More specifically, the estimation unit 63 extends, from a coordinate C1 corresponding to the time t4 on the approximate curve L10, a curve L21 (plotted as a dashed curve) having the same shape as the approximate curve L20. The estimation unit 63 estimates that the failure diagnostic values from the time t4 on will be represented by the curve L21. Thus, in the example shown in FIG. 4, the estimation unit 63 estimates that the failure diagnostic value will reach the threshold value Th1 at a time t6. The estimation unit 63 obtains, as the expected lifetime information, the amount of time that has passed from the time t4 to the time t6. The difference between the cumulative operating hours of the electric tool section 1 at the time t3 and the cumulative operating hours of the electric tool section 1 at the time t4 may be, for example, the operating hours of the electric tool section 1 which has been used at a factory for about one month to a few months, for example. The estimation unit 63 may obtain the expected lifetime information accurately by plotting the approximate curve L20 based on the failure diagnostic values in the latest period preceding the current time.

In still another example, the estimation unit 63 may obtain the expected lifetime information based on the failure diagnostic value at the current time (e.g., time t4) and the failure diagnostic values belonging to a period (e.g., from the time t1 through the time t2) preceding the current time and the time information, instead of the failure diagnostic values belonging to the entire period and the time information which are stored in the storage unit 62. More specifically, the estimation unit 63 plots an approximate curve L30 (plotted as a two-dot chain curve) showing how the failure diagnostic value changes from the time t1 through the time t2. Then, the estimation unit 63 estimates, on the supposition that failure diagnostic value changes along the approximate curve L30 from the time t4 on, the failure diagnostic values from the point t4 on. More specifically, the estimation unit 63 extends, from the coordinate C1 corresponding to the time t4 on the approximate curve L10, a curve L31 (plotted as a dashed curve) having the same shape as the approximate curve L30. The estimation unit 63 estimates that the failure diagnostic values from the time t4 on will be represented by the curve L31. Thus, in the example shown in FIG. 4, the estimation unit 63 estimates that the failure diagnostic value will reach the threshold value Th1 at a time t7. The estimation unit 63 obtains, as the expected lifetime information, the amount of time that has passed from the time t4 to the time t7. For example, if the current time (time t4) belongs to the summer season, the estimation unit 63 plots the approximate curve L30 based on the failure diagnostic values belonging to the last summer (from the time t1 through the time t2). That is to say, the estimation unit 63 plots the approximate curve L30 based on the failure diagnostic values belonging to a season, of which the condition is either the same as, or similar to, the condition of the current time. This allows the expected lifetime information to be obtained accurately.

The communications unit 61 of the linkage device 6 transmits, to the electric tool section 1, the expected lifetime information obtained by the estimation unit 63. In response, the notification unit 231 of the electric tool section 1 makes notification of the expected lifetime information. Optionally, the notification unit 231 may be configured not to make notification of the expected lifetime information until the failure diagnostic value at the current time exceeds a predetermined value. The predetermined value is less than the threshold value Th1.

The initial value of the threshold value Th1 is stored in advance in the storage unit 62. The communications unit 51 of the electric tool section 1 transmits update information for use to update the threshold value Th1 to the communications unit 61 of the linkage device 6. This allows the threshold value Th1 stored in the storage unit 62 to be updated.

Taking the electric tool section 1A out of the two electric tool sections 1A, 1B, the setter 533 of the electric tool section 1A sets the predetermined range (threshold value Th1) in accordance with information provided by the electric tool section 1B, which is provided separately from the electric tool section 1A. In other words, the setter 533 of the electric tool section 1A generates the update information in accordance with the information provided by the electric tool section 1B provided separately from the electric tool section 1A.

Suppose, for example, the electric tool section 1A is used under the same condition as the electric tool section 1B and the electric tool section 1B has longer cumulative operating hours than the electric tool section 1A. The estimation unit 63 of the linkage device 6 obtains the failure diagnostic value of the electric tool section 1B. If estimation is made that the failure diagnostic value of the electric tool section 1B will reach the threshold value Th1 later than its product lifetime, then the current threshold value Th1 would be too large. Thus, the linkage device 6 transmits update information for use to decrease the threshold value Th1 to the electric tool section 1A.

Optionally, the threshold value Th1 may be updated in accordance with an operating command entered by the user via the operating unit 232.

### Variations of Embodiment

Next, variations of the exemplary embodiment will be enumerated one after another. Note that the variations to be described below may be adopted in combination as appropriate.

The processing of fitting the failure diagnostic values that change from the time t0 through the time t4 to the approximate curve L10 is not indispensable for the estimation unit 63 to estimate future failure diagnostic values. In the embodiment described above, future failure diagnostic values are estimated by, for example, extending the curve L21, having the same shape as the approximate curve L20 between the time t3 and the time t4, from the coordinate C1 corresponding to the time t4 on the approximate curve L10. Alternatively, future failure diagnostic values may also be estimated by extending the curve L21 from a coordinate C2 (refer to FIG. 4) representing the failure diagnostic value corresponding to the current time (time t4) which has been calculated based on the physical quantity measured by the measuring unit 4, for example. Also, in the embodiment described above, future failure diagnostic values are estimated by extending the curve L31, having the same shape as the approximate curve L30 between the time t1 and the time t2, from the coordinate C1 corresponding to the time t4 on the approximate curve L10. Alternatively, future failure diagnostic values may also be estimated by extending the curve L31 from the coordinate C2 (refer to FIG. 4) representing the failure diagnostic value corresponding to the current time (time t4) which has been calculated based on the physical quantity measured by the measuring unit 4, for example.

In the exemplary embodiment described above, the estimation unit 63 defines a value calculated by subtracting the actually measured torque from the theoretical torque to be the failure diagnostic value. Alternatively, the estimation unit 63 may also define the actually measured torque (i.e., the torque measured by the measuring unit 4) to be the failure diagnostic value. Still alternatively, the estimation unit 63 may also define both the value calculated by subtracting the actually measured torque from the theoretical torque and the actually measured torque to be failure diagnostic values and may obtain the expected lifetime information using both of these two failure diagnostic values.

In the exemplary embodiment described above, the time information is a piece of information indicating the time and date when the measuring unit 4 measured the physical quantity. Alternatively, the time information may also be a piece of information indicating the cumulative operating hours of the electric tool section 1 at a point in time when the measuring unit 4 measured the physical quantity, for example.

In the exemplary embodiment described above, the processing of calculating the failure diagnostic value based on the current and the torque is performed by the linkage device 6. Alternatively, the processing of calculating the failure diagnostic value may also be performed by the processing unit 53 of the electric tool section 1.

The physical quantities measured by the measuring unit 4 are not limited to current and torque. Alternatively, the physical quantity measured by the measuring unit 4 may also be, for example, a physical quantity representing the vibration of the electric tool section 1 (e.g., the magnitude of the vibration).

The transmission part 32 may include an impact mechanism for applying impacting force (impact) to the attachment part 33 using the torque applied by the driving part 31. That is to say, the electric tool section 1 may be an impact tool.

The notification unit 231 does not have to be configured to make notification of the expected lifetime information visually. Alternatively, the notification unit 231 may also make notification of the expected lifetime information either as a sound (such as a voice) or vibration. Still alternatively, the notification unit 231 may also be implemented as, for example, a transmitter for transmitting a notification signal to an external terminal device (such as a mobile device) outside of the electric tool section 1.

The linkage device 6 may include the notification unit 231.

The notification unit 231 for making notification of the expected lifetime information is not an essential constituent element for the electric tool system 100. Optionally, the expected lifetime information may also be used for a computer system to create a management (such as maintenance and replacement) plan of the electric tool section 1, for example.

The expected lifetime information about the estimated amount of time that it would take for the electric tool section 1 to cause any failure may also be a piece of information indicating a point in time when the electric tool section 1 is expected to cause a failure. Alternatively, the expected lifetime information may also be a piece of information indicating an estimated amount of time that it would take for the failure diagnostic value to reach a value falling within a predetermined range from either the current time or a predetermined point in time preceding or following the current time.

Optionally, the expected lifetime information may also be a numerical value obtained by converting the estimated amount of time that it would take for the electric tool section 1 to cause any failure into the number of times the operations may be performed before any failure occurs.

For example, the expected lifetime information may represent the number of screws that may be fastened before the electric tool section 1 causes any failure.

The electric tool system 100 according to the present disclosure or the agent that performs the diagnosis method according to the present disclosure includes a computer system. The computer system may include a processor and a memory as principal hardware components thereof. The computer system performs at least some functions of the electric tool system 100 according to the present disclosure or serves as the agent that performs the diagnosis method according to the present disclosure by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Optionally, the plurality of functions of the linkage device 6 may be distributed in multiple devices. Furthermore, at least some functions of the linkage device 6 may be implemented as either a server or a cloud computing system.

Furthermore, the constituent elements of the electric tool system 100 may be distributed in multiple devices. For example, the electric tool section 1 including at least the activating unit 3 may be provided separately from at least one of the measuring unit 4, the communications unit 51, the storage unit 52, the processing unit 53, or the notification unit 231.

Furthermore, at least some functions of the electric tool system 100 which are distributed in the linkage device 6 and the electric tool section 1 in the exemplary embodiment described above may be aggregated together in a single device. For example, in the exemplary embodiment described above, the linkage device 6 is provided separately from the electric tool section 1 and the linkage device 6 includes the estimation unit 63. Alternatively, the electric tool section 1 may include the estimation unit 63. In that case, the linkage device 6 does not have to be one of constituent elements of the electric tool system 100. Still alternatively, the electric tool section 1 may have some functions of the estimation unit 63.

### Recapitulation

The exemplary embodiment and its variations described above are specific implementations of the following aspects of the present disclosure.

An electric tool system (100) according to a first aspect includes an electric tool section (1), a measuring unit (4), a storage unit (62), and an estimation unit (63). The electric tool section (1) includes a driving part (31), an attachment part (33), and a transmission part (32). The driving part (31) is supplied with motive power by a power source (P11) to generate torque. A tip tool is attachable to the attachment part (33). The transmission part (32) transmits the torque from the driving part (31) to the attachment part (33) and thereby drives the attachment part (33). The measuring unit (4) measures a physical quantity concerning the electric tool section (1). The storage unit (62) stores a failure diagnostic value in association with time information about a point in time when the physical quantity is measured. The failure diagnostic value is at least one of the physical quantity measured by the measuring unit (4) or an arithmetic value calculated based on the physical quantity. The estimation unit (63) obtains, based on the failure diagnostic value and the time information that are stored in the storage unit (62), expected lifetime information about an estimated amount of time that is expected to take for the electric tool section (1) to cause any failure.

According to this configuration, the estimation unit (63) obtains expected lifetime information about an estimated amount of time that it would take for the electric tool section (1) to cause any failure, thus making it easier for the user, for example, to decide, by reference to the expected lifetime information, when it is about time to make management (such as maintenance and replacement) of the electric tool section (1).

An electric tool system (100) according to a second aspect, which may be implemented in conjunction with the first aspect, further includes a notification unit (231). The notification unit (231) makes notification of the expected lifetime information obtained by the estimation unit (63).

This configuration makes it easier for the user, for example, to decide, by reference to the expected lifetime information, when it is about time to make management (such as maintenance and replacement) of the electric tool section (1).

An electric tool system (100) according to a third aspect, which may be implemented in conjunction with the second aspect, further includes a restrictor (532). The restrictor (532) restricts, while the attachment part (33) is being driven, the notification of the expected lifetime information to be made by the notification unit (231).

This configuration may reduce the chances of causing, while the user is performing operations using the electric tool section (1), the notification made by the notification unit (231) to attract the user's attention and thereby disturb the user in his or her operations.

In an electric tool system (100) according to a fourth aspect, which may be implemented in conjunction with any one of the first to third aspects, the estimation unit (63) obtains, as the expected lifetime information, an estimated amount of time that is expected to take for the failure diagnostic value to reach a value falling within a predetermined range.

This configuration makes it easier for the estimation unit (63) to obtain the expected lifetime information based on the failure diagnostic value.

An electric tool system (100) according to a fifth aspect, which may be implemented in conjunction with the fourth aspect, further includes a setter (533). The setter (533) sets the predetermined range in accordance with information provided by an additional electric tool section (1B). The additional electric tool section (1B) is provided separately from the electric tool section (1A).

This configuration makes it easier for the setter (533) to set an appropriate range as the predetermined range.

In an electric tool system (100) according to a sixth aspect, which may be implemented in conjunction with any one of the first to fifth aspects, the estimation unit (63) obtains the expected lifetime information based on a plurality of the failure diagnostic values belonging to an entire period and the time information. The plurality of the failure diagnostic values and the time information are stored in the storage unit (62).

This configuration allows the estimation unit (63) to obtain expected lifetime information according to, for example, the past status of usage of the electric tool section (1).

In an electric tool system (100) according to a seventh aspect, which may be implemented in conjunction with any one of the first to fifth aspects, the estimation unit (63) obtains the expected lifetime information based on only a plurality of the failure diagnostic values, belonging to a partial period that forms part of an entire period, and the time information, instead of the plurality of the failure diagnostic values belonging to the entire period and the time information which are stored in the storage unit (62). The partial period is a period from a point in time preceding a current time through the current time.

This configuration allows the failure diagnostic values belonging to the latest period preceding the current time to be reflected on the expected lifetime information obtained by the estimation unit (63). That is to say, this allows the estimation unit (63) to obtain the expected lifetime information according to, for example, the latest status of usage of the electric tool section (1).

In an electric tool system (100) according to an eighth aspect, which may be implemented in conjunction with any one of the first to fifth aspects, the estimation unit (63) obtains the expected lifetime information based on only a failure diagnostic value corresponding to a current time and a plurality of failure diagnostic values belonging to a period preceding the current time and the time information, instead of the plurality of the failure diagnostic values belonging to an entire period and the time information which are stored in the storage unit (62).

This configuration allows the failure diagnostic values belonging to a predetermined period in the past to be reflected on the expected lifetime information obtained by the estimation unit (63). That is to say, this allows the estimation unit (63) to obtain the expected lifetime information according to, for example, the past status of usage of the electric tool section (1).

In an electric tool system (100) according to a ninth aspect, which may be implemented in conjunction with any one of the first to eighth aspects, the failure diagnostic value includes a value calculated by subtracting actually measured torque from theoretical torque. The theoretical torque is torque calculated based on a value obtained by having a current supplied from the power source (P11) to the driving part (31) measured by the measuring unit (4). The actually measured torque is torque measured by the measuring unit (4) based on strain generated by application of torque to the attachment part (33).

This configuration allows a versatile sensor to be used as the measuring unit (4).

In an electric tool system (100) according to a tenth aspect, which may be implemented in conjunction with any one of the first to ninth aspects, the failure diagnostic value includes torque measured by the measuring unit (4) based on strain generated by application of torque to the attachment part (33).

This configuration allows a versatile sensor to be used as the measuring unit (4).

In an electric tool system (100) according to an eleventh aspect, which may be implemented in conjunction with any one of the first to tenth aspects, the physical quantity includes a physical quantity concerning vibration of the electric tool section (1).

This configuration allows a versatile sensor to be used as the measuring unit (4).

Note that the constituent elements according to the second to eleventh aspects are not essential constituent elements for the electric tool system (100) but may be omitted as appropriate.

A diagnosis method according to a twelfth aspect is a method for making a diagnosis about an electric tool section (1). The electric tool section (1) includes a driving part (31), an attachment part (33), and a transmission part (32). The driving part (31) is supplied with motive power by a power source (P11) to generate torque. A tip tool is attachable to the attachment part (33). The transmission part (32) transmits the torque from the driving part (31) to the attachment part (33) and thereby drives the attachment part (33). The diagnosis method includes a storing step and an estimating step. The storing step includes storing, in a storage unit (62), a failure diagnostic value in association with time information about a point in time when a physical quantity concerning the electric tool section (1) is measured by a measuring unit (4). The failure diagnostic value is at least one of the physical quantity concerning the electric tool section (1) which has been measured by the measuring unit (4) or an arithmetic value calculated based on the physical quantity. The estimating step includes obtaining, based on the failure diagnostic value and the time information that are stored in the storage unit (62), expected lifetime information about an estimated amount of time that is expected to take for the electric tool section (1) to cause any failure.

This method makes it easier for the user, for example, to decide, by reference to the expected lifetime information, when it is about time to make management (such as maintenance and replacement) of the electric tool section (1).

A program according to a thirteenth aspect is designed to cause one or more processors of a computer system to perform the diagnosis method according to the twelfth aspect.

This program makes it easier for the user, for example, to decide, by reference to the expected lifetime information, when it is about time to make management (such as maintenance and replacement) of the electric tool section (1).

Note that these are not the only aspects of the present disclosure but various configurations (including variations) of the electric tool system (100) according to the exemplary embodiment described above may also be implemented as, for example, a diagnosis method, a (computer) program, or a non-transitory storage medium on which the program is stored.

### REFERENCE SIGNS LIST

1 Electric Tool Section
4 Measuring Unit
31 Driving Part
32 Transmission Part
33 Attachment Part
62 Storage Unit
63 Estimation Unit
100 Electric Tool System
231 Notification Unit
532 Restrictor
533 Setter
P11 Power Source

1. An electric tool system comprising
an electric tool section,
a measuring unit,
a storage unit, and
an estimation unit,
the electric tool section including:
a driving part configured to be supplied with motive power by a power source and thereby generate torque;
an attachment part to which a tip tool is attachable; and
a transmission part configured to transmit the torque from the driving part to the attachment part and thereby drive the attachment part,
the measuring unit being configured to measure a physical quantity concerning the electric tool section,
the storage unit being configured to store a failure diagnostic value in association with time information about a point in time when the physical quantity is measured, the failure diagnostic value being at least one of the physical quantity measured by the measuring unit or an arithmetic value calculated based on the physical quantity, and
the estimation unit being configured to obtain, based on the failure diagnostic value and the time information that are stored in the storage unit, expected lifetime information about an estimated amount of time that is expected to take for the electric tool section to cause any failure.

2. The electric tool system of claim 1, further comprising a notification unit configured to make notification of the expected lifetime information obtained by the estimation unit.

3. The electric tool system of claim 2, further comprising a restrictor configured to restrict, while the attachment part is being driven, the notification of the expected lifetime information to be made by the notification unit.

4. The electric tool system of claim 1, wherein
the estimation unit is configured to obtain, as the expected lifetime information, an estimated amount of time that is expected to take for the failure diagnostic value to reach a value falling within a predetermined range.

5. The electric tool system of claim 4, further comprising a setter configured to set the predetermined range in accordance with information provided by an additional electric tool section, the additional electric tool section being provided separately from the electric tool section.

6. The electric tool system of claim 1, wherein
the estimation unit is configured to obtain the expected lifetime information based on a plurality of the failure diagnostic values belonging to an entire period and the time information, the plurality of the failure diagnostic values and the time information being stored in the storage unit.

7. The electric tool system of claim 1, wherein
the estimation unit is configured to obtain the expected lifetime information based on only a plurality of the failure diagnostic values, belonging to a partial period that forms part of an entire period, and the time information, instead of the plurality of the failure diagnostic values belonging to the entire period and the time information which are stored in the storage unit, the partial period being a period from a point in time preceding a current time through the current time.

8. The electric tool system of claim 1, wherein
the estimation unit is configured to obtain the expected lifetime information based on only a failure diagnostic value corresponding to a current time and a plurality of the failure diagnostic values belonging to a period preceding the current time and the time information, instead of the plurality of the failure diagnostic values belonging to an entire period and the time information which are stored in the storage unit.

9. The electric tool system of claim 1, wherein
the failure diagnostic value includes a value calculated by subtracting actually measured torque from theoretical torque, the theoretical torque being torque calculated based on a value obtained by having a current supplied from the power source to the driving part measured by the measuring unit, the actually measured torque being torque measured by the measuring unit based on strain generated by application of torque to the attachment part.

10. The electric tool system of claim 1, wherein
the failure diagnostic value includes torque measured by the measuring unit based on strain generated by application of torque to the attachment part.

11. The electric tool system of claim 1, wherein
the physical quantity includes a physical quantity concerning vibration of the electric tool section.

12. A diagnosis method for making a diagnosis about an electric tool section,
the electric tool section including:
a driving part configured to be supplied with motive power by a power source and thereby generate torque;
an attachment part to which a tip tool is attachable; and
a transmission part configured to transmit the torque from the driving part to the attachment part and thereby drive the attachment part,
the diagnosis method comprising:
a storing step including storing, in a storage unit, a failure diagnostic value in association with time information about a point in time when a physical quantity concerning the electric tool section is measured by a measuring unit, the failure diagnostic value being at least one of the physical quantity concerning the electric tool section which has been measured by the measuring unit or an arithmetic value calculated based on the physical quantity; and
an estimating step including obtaining, based on the failure diagnostic value and the time information that are stored in the storage unit, expected lifetime information about an estimated amount of time that is expected to take for the electric tool section to cause any failure.

13. A non-transitory storage medium storing thereon a program designed to cause one or more processors of a computer system to perform the diagnosis method of claim 12.
